(19) United States
(12) Patent Application Publication
(10) Pub. No.: US 2011/0069509 A1
(43) Pub. Date: Mar. 24, 2011

(54) BACKLIGHT MODULE

(75) Inventors: Hung-Chih Lin, Hsin-Chu (TW); Yi-Wen Lin, Hsin-Chu (TW)

(73) Assignee: YOUNG LIGHTING TECHNOLOGY CORPORATION, Hsin-Chu (TW)

(21) Appl. No.: 12/869,774

(22) Filed: Aug. 27, 2010

(30) Foreign Application Priority Data
Sep. 21, 2009 (TW) 98131781

(51) Int. Cl. F21V 7/22

(52) U.S. Cl. 362/607; 362/613; 362/612

(57) ABSTRACT

A backlight module includes a back plate, a plurality of position limiting elements, a light guiding plate, and a light source. The position limiting elements are disposed on the back plate, and each of the position limiting elements includes a pillar and a cushion sheath covering the pillar. The light guiding plate is disposed on the back plate, and has a plurality of first position limiting portions. The first position limiting portions respectively contact the position limiting elements to position the light guiding plate on the back plate. The light source is disposed at a side of the light guiding plate.

### CROSS-REFERENCE TO RELATED APPLICATION

This application claims the priority benefit of Taiwan application serial No. 98131781, filed on Sep. 21, 2009. The entirety of the above-mentioned patent application is hereby incorporated by reference herein and made a part of this specification.

### BACKGROUND OF THE INVENTION

1. Field of the Invention

The invention relates to a light source module, and more particularly, to a backlight module adapted to a liquid crystal display (LCD).

2. Description of Related Art

A liquid crystal display (LCD) mainly includes an LCD panel and a backlight module, wherein the backlight module is a planar light source disposed behind the LCD panel. The backlight modules may be grouped into direct type backlight modules and edge lighting backlight modules according to different configurations of lamps of the backlight modules.

Taking the edge lighting backlight module as an example, a principle of the edge lighting backlight module is to dispose a light source at a side of a light guiding plate, so that a light beam may be incident from a side surface of the light guiding plate, and emitted out from a front surface of the light guiding plate. U.S. Pat. No. 7,359,614 discloses an edge lighting backlight module, wherein at least one pillar is provided to associate with an arc angle on the light guiding plate, so that the light guiding plate and the pillar are maintained to a planar contact state, so as to avoid a light gathering phenomenon of the light guiding plate, and accordingly avoid light-leakage. Moreover, the pillar may position the light guiding plate, so that the light guiding plate is not slid during a movement, and the pillar may further provide a support, so that the structure strength of the backlight module is increased.

However, when the backlight module is impacted or in a vibration state, the pillar is liable to scrape the light guiding plate. Based on a structural consideration, a material of the pillar is preferably metal, so that the light guiding plate may generate scrapings, or even be seriously damaged (such as cracked, etc.).

### SUMMARY OF THE INVENTION

The invention is directed to a backlight module having a good durability.

Additional aspects and advantages of the invention will be set forth in the description of the techniques disclosed in the invention.

To achieve at least one of the advantages, one embodiment of the invention provides a backlight module including a back plate, a plurality of position limiting elements, a light guiding plate, and a light source. The position limiting elements are disposed on the back plate, and each of the position limiting elements includes a pillar and a cushion sheath covering the pillar. The light guiding plate is disposed on the back plate, and has a plurality of first position limiting portions. The first position limiting portions respectively contact the position limiting elements to position the light guiding plate on the back plate. The light source is disposed at a side of the light guiding plate.

According to the above description, by covering the cushion sheath on the pillar, the light guiding plate may be positioned on the back plate, and the cushion sheath is located between the pillar and the light guiding plate, so as to protect the pillar and the light guiding plate. When the backlight module is vibrated or impacted, the cushion sheath may absorb a vibration force or an impact force, so as to avoid a direct scraping between the pillar and the light guiding plate. Therefore, the backlight module has a good durability.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an exploded view of a backlight module according to an embodiment of the invention.

FIG. 2 is a schematic view illustrating some of members of a backlight module of FIG. 1 after being assembled.

FIG. 3 is a top view of some of members of a backlight module of FIG. 2.

FIG. 4 is a cross-sectional view of a backlight module of FIG. 3 taken along line A-A.

FIG. 5 is a partial enlarged view of a backlight module according to another embodiment of the invention.

FIG. 6 is a partial enlarged view of a backlight module according to another embodiment of the invention.

FIG. 7 is a partial enlarged view of a backlight module according to another embodiment of the invention.

FIG. 8 is a partial enlarged view of a backlight module according to another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacently to” and variations thereof herein are used broadly and encompass directly and indirectly “adjacently to”. Therefore, the description of “A” component facing “B” component herein may contain the situations that “A” component directly faces “B” component or one or more additional components are between “A” component and “B” component. Also, the description of “A” component “adjacently to” “B” component herein may contain the situations that “A” component is directly “adjacently to” “B” component or one or more additional components are between “A” component and “B” component. Accordingly, the drawings and descriptions will be regarded as illustrative in nature and not as restrictive.

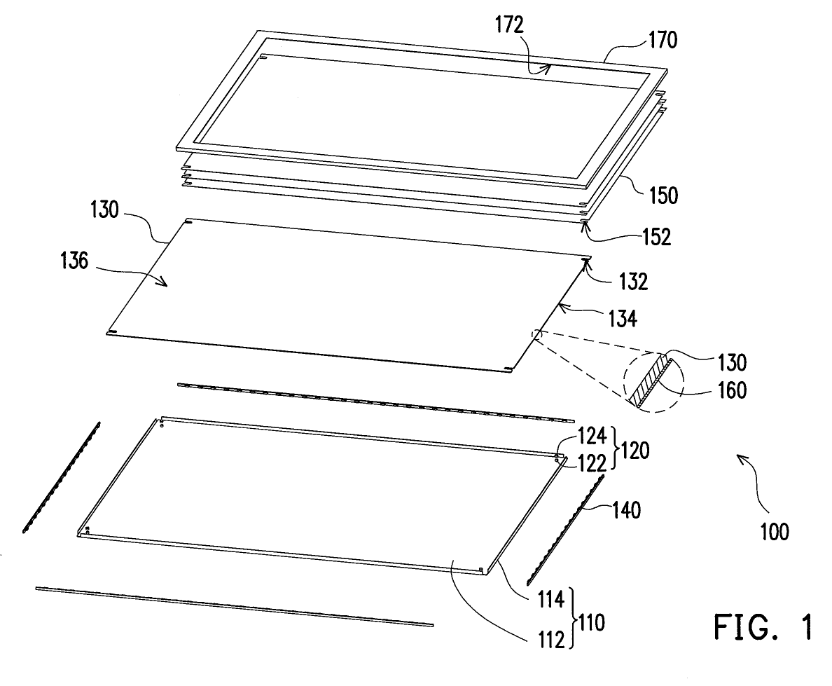

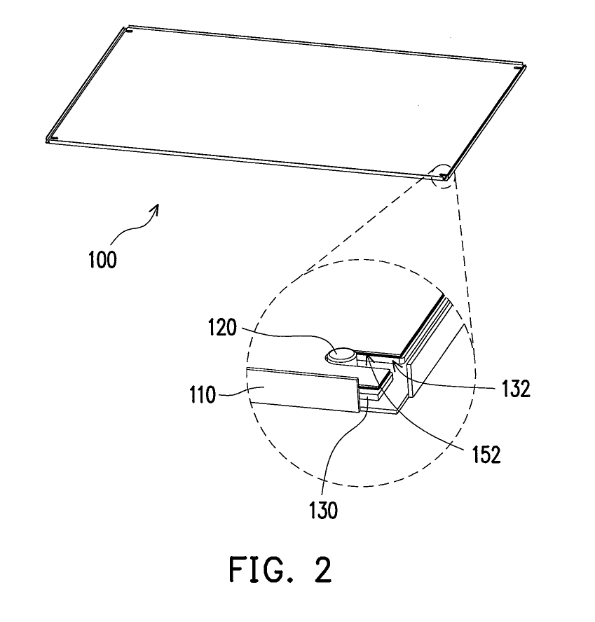

Referring to FIG. 1 and FIG. 2, the backlight muddle 100 includes a back plate 110, a plurality of position limiting elements 120, a light guiding plate 130, and a light source 140. In the embodiment, a shape of the back plate 110 is substantially a rectangle, and the back plate 110 includes a bottom portion 112 and four side portions 114 extended from four sides of the bottom portion 112 and perpendicular to the bottom portion 112. The light source 140 is, for example, a plurality of light emitting diodes (LEDs) respectively disposed between the side portions 114 and the light guiding plate 130. However, implementation of the light source 140 is not limited by the embodiment, and in another embodiment, the light source 140 may also be one or a plurality of cold cathode fluorescent lamps (CCFLs).

The position limiting elements 120 are disposed on the back plate 110, and each of the position limiting elements 120 includes a pillar 122 and a cushion sheath 124 covering the pillar 122. In the embodiment, the pillar 122 is a metal pillar (for example, a copper pillar) having a structure independent to the back plate 110, and the pillar 122 is externally assembled to the back plate 110. However, in other embodiments, the pillar 122 may also be directly formed by a small portion of the back plate 110. A material of the cushion sheath 124 is silicone, rubber or foam, and the cushion sheath 124 is used for cushioning an impact effect, though the embodiment is not limited to the materials.

The light guiding plate 130 has a plurality of first position limiting portions 132. The first position limiting portions 132 include a plurality of grooves. The first position limiting portions 132 respectively contact the position limiting elements 120 to position the light guiding plate 130 on the back plate 110, and the cushion sheaths 124 may cushion impacts between the pillars 122 and the light guiding plate 130. In detail, by using the first position limiting portions 132 of the light guiding plate 130 and the position limiting elements 120, two degrees of freedom of the light guiding plate 130 being shifted on a geometric plane substantially parallel to the bottom portion 112 of the back plate 110 are limited.

Moreover, the light source 140 disposed at the side portion 114 is adjacent to a side surface 134 of the light guiding plate 130, so that a light beam generated by the light source 140 may be incident to the light guiding plate 130 from the side surface 134 of the light guiding plate 130, and may be emitted out from a light emitting surface 136 of the light guiding plate 130. Here, the position and the quantity of the light sources 140 are not limited. As long as the light sources 140 are disposed at the side portions 114, and the light beams generated by the light sources 140 may be incident to the light guiding plate 130 from the side surface 134 of the light guiding plate 130, and in the embodiment, the light sources 140 may be disposed at one, two, three or all of the side portions 114.

Referring to FIG. 1 and FIG. 2, in the embodiment, the backlight module 100 further includes one or a plurality of optical films 150, and the optical films 150 are, for example, diffuser films, brightness enhancement films, or other optical films. The optical films 150 are sequentially stacked on the light emitting surface 136 of the light guiding plate 130, and each of the optical films 150 has a plurality of second position limiting portions 152. Similar to the first position limiting portions 132 of the light guiding plate 130, the second position limiting portions 152 also include a plurality of grooves, and the second position limiting portions 152 respectively contact the position limiting elements 120 to position the optical films 150 on the light guiding plate 130.

Referring to FIG. 1 again, in the embodiment, the backlight module 100 further includes a light reflecting layer 160, and the light reflecting layer 160 is disposed between the back plate 110 and the light guiding plate 130 for reflecting the light beam of the light source 140, and the light beam of the source 140 is incident to the light guiding plate 130 and is emitted out from a bottom surface of the light guiding plate 130 to the light emitting surface 136 of the light guiding plate 130, so that the light beam may be effectively used, and a brightness of the light beam provided by the backlight module 100 may be increased. In the embodiment, the light reflecting layer 160 is, for example, a coating layer coated on the bottom surface of the light guiding plate 130. However, in other embodiments, the light reflecting layer 160 may also be a light reflecting sheet disposed between the back plate 110 and the light guiding plate 130.

Referring to FIG. 1 again, in the embodiment, the backlight module 100 further includes a frame 170, and the frame 170 is assembled to the back plate 110 to avoid the light guiding plate 130 and the optical films 150 falling off the back plate 110. Moreover, the frame 170 further has a window 172, so that the light beam emitted out from the light emitting surface 136 of the light guiding plate 130 may pass through the window 172.

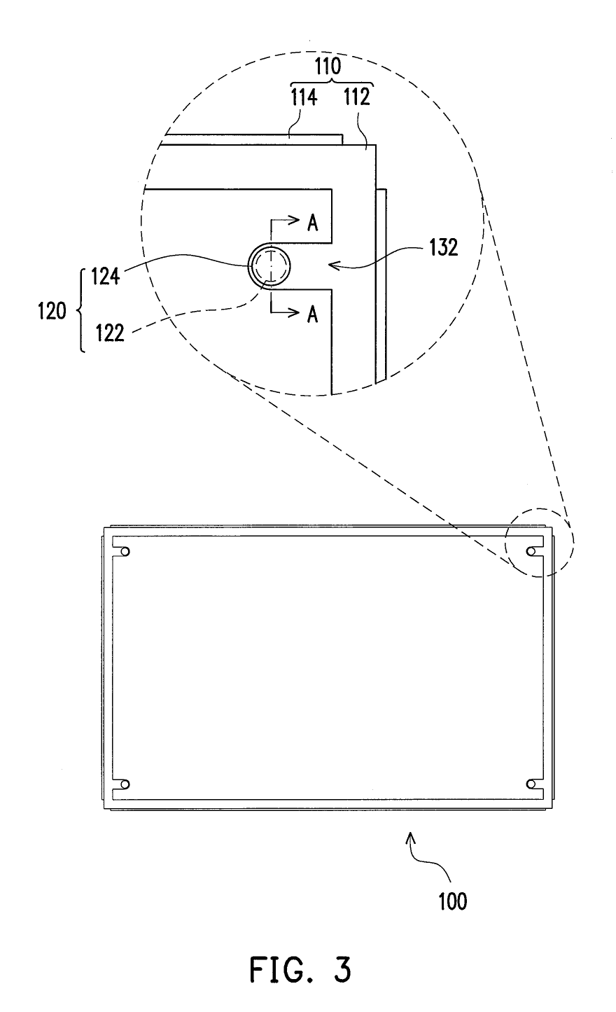

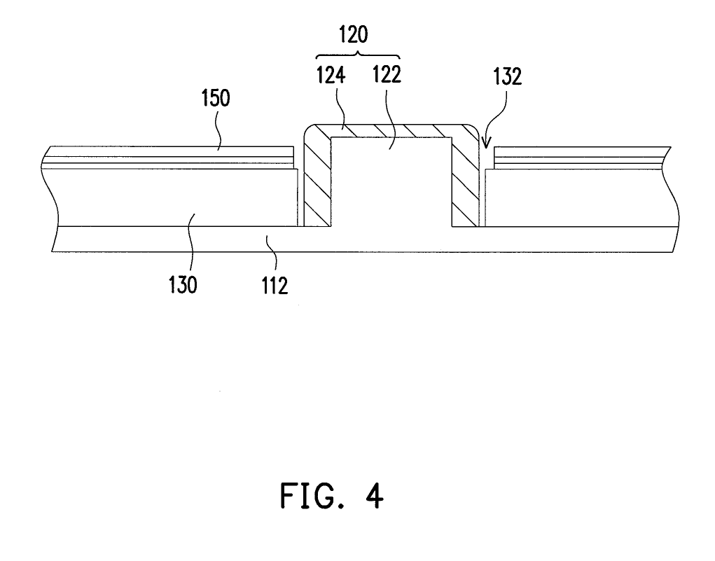

Referring to FIG. 3 and FIG. 4, the position limiting elements 120 are symmetrically disposed around the back plate 110. In the embodiment, the position limiting elements 120 are respectively located at four corners of the back plate 110 to avoid a light incident path of the light source 140, so that the light beam may be incident to the light guiding plate 130 from the side surface 134 of the light guiding plate 130 without being blocked, and the light beam output from the backlight module 100 may have a relatively high brightness. In another embodiment, the position limiting elements 120 are also disposed at two corners of any diagonal of the back plate 110.

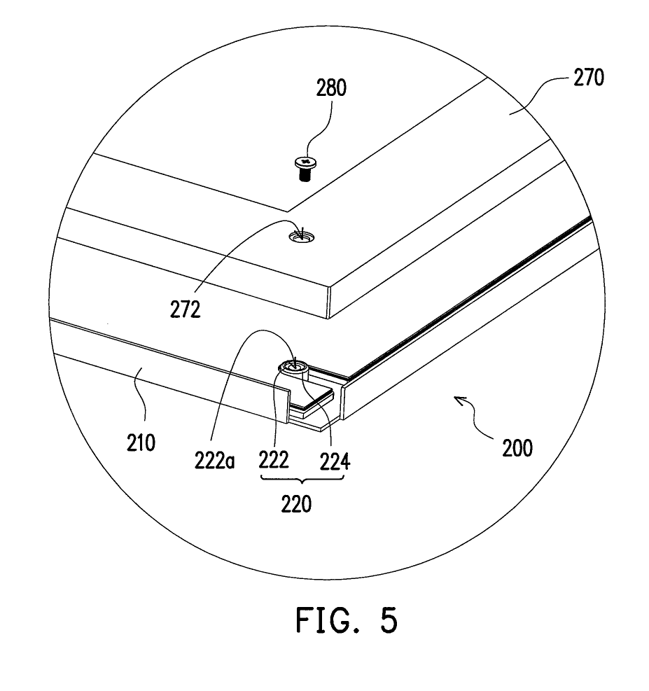

Referring to FIG. 5, the backlight module 200 of the embodiment further has a plurality of fastening members 280 (for example, screws), and the pillar 222 of each of the position limiting elements 220 on the back plate 210 has a fastening hole 222a. The fastening hole 222a is exposed by the cushion sheath 224, and the frame 270 has a plurality of openings 272 corresponding to the fastening holes 222a. Therefore, by fastening the fastening members 280 passing through the openings 272 in the fastening holes 222a, the frame 270 is fastened to the back plate 210.

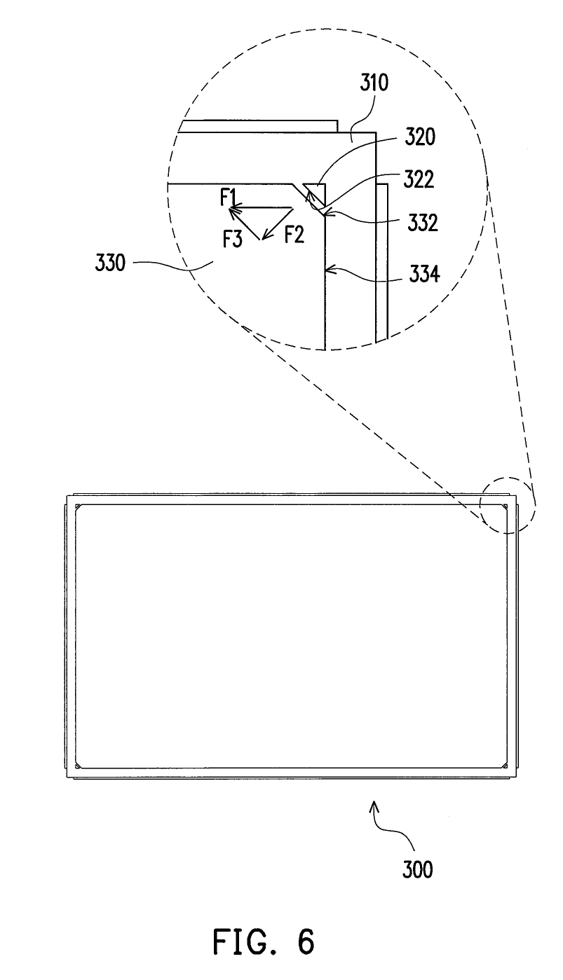

Referring to FIG. 6, in the backlight module 300, the light guiding plate 330 has a plurality of first position limiting planes 332, and the first position limiting planes 332 are oblique to the side surface 334 of the light guiding plate 330. The position limiting elements 320 are triangular pillars, and have second position limiting planes 322 corresponding to the first position limiting planes 332. The first position limiting planes 332 respectively contact to the second position limiting planes 322, so the light guiding plate 330 may be positioned on the back plate 310.

When the backlight module 300 sustains an external impact from the right, the light guiding plate 330 sustains a force F1 exerted by the position limiting element 320. Due to a plane contact between the first position limiting plane 332 and the second position limiting plane 322, the force F1 is divided into two sub-forces F2 and F3, wherein the sub-force F2 is perpendicular to the first position limiting plane 332, and the sub-force F3 is parallel to the first position limiting plane 332, and only the sub-force F2 perpendicular to the first position limiting plane 332 is operative to the light guiding plate 330. Therefore, the sub-force F2 sustained by the light guiding plate 330 is less than the force F1, so that damage of the light guiding plate 330 due to excessive impact may be avoided.

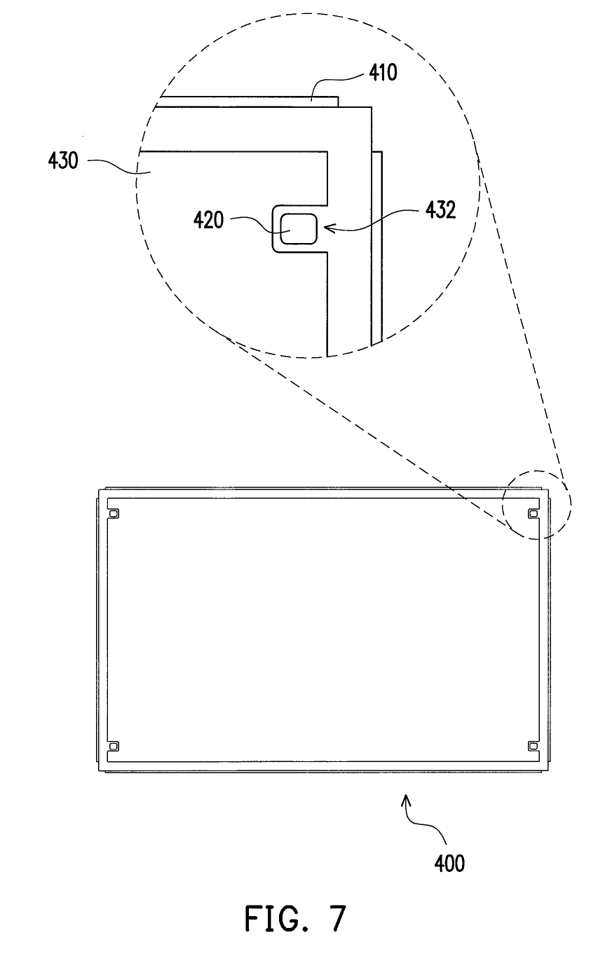

Referring to FIG. 7, in the backlight module 400, the position limiting element 420 is a rectangular pillar, and the first position limiting portion 432 of the light guiding plate 430 is a corresponding rectangular groove. The first position limiting portions 432 respectively contact to the position limiting elements 420, so the light guiding plate 430 is positioned on the back plate 410.

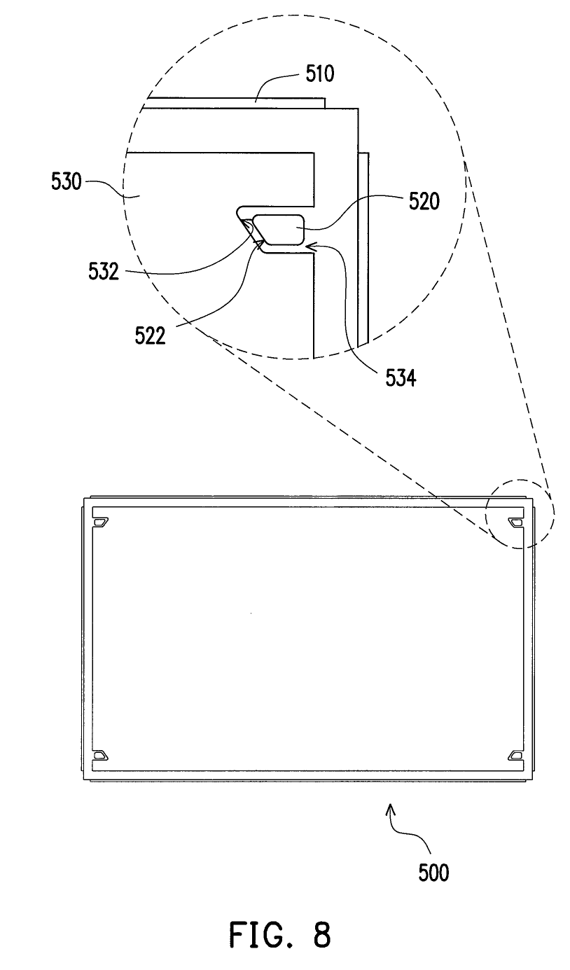

Referring to FIG. 8, in the backlight module 500, the position limiting element 520 is a trapezoidal pillar, and the first position limiting portion 534 of the light guiding plate 530 is a corresponding trapezoidal groove. The first position limiting portions 534 are respectively contact to the position limiting elements 520, so the light guiding plate 530 is positioned on the back plate 510. Moreover, the position limiting element 520 has a second position limiting plane 522, and the light guiding plate 530 has a first position limiting plane 532 corresponding to the second position limiting plane 522. Therefore, as described in the embodiment of FIG. 6, an impact between the light guiding plate 530 and the position limiting element 520 is cushioned, so as to avoid the damage of the light guiding plate 530 due to excessive impact.

In the above embodiments of the invention, a shape of the position limiting element is not limited, and the shape of the position limiting element may be a column of FIG. 3, a triangle pillar of FIG. 6, a rectangular pillar of FIG. 7 or a trapezoidal pillar of FIG. 8. Any types of the position limiting element covered by the cushion sheath capable of absorbing the impact between the light guiding plate and the position limiting element to avoid damage of the light guiding plate is adapted to the invention.

In summary, the embodiment or the embodiments of the invention may have at least one of the advantages, by the position limiting elements and the position limiting portions of the light guiding plate, the light guiding plate may be positioned on the back plate, and the cushion sheath covering the pillar is used to cushion the impact between the pillar and the light guiding plate, so as to avoid damage of the light guiding plate due to excessive impact. Moreover, since the position limiting element and the light guiding plate respectively have the corresponding position limiting planes oblique to the side surface of the light guiding plate, the impact between the light guiding plate and the position limiting elements may be cushioned due to a force differentiation, so that damage of the light guiding plate due to excessive impact may be avoided.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A backlight module, comprising:
a back plate;
a plurality of position limiting elements, disposed on the back plate, and each of the position limiting elements comprising:
a pillar; and
a cushion sheath, covering the pillar;
a light guiding plate, disposed on the back plate, and having a plurality of first position limiting portions, wherein the first position limiting portions respectively contact the position limiting elements to position the light guiding plate on the back plate; and
a light source, disposed at a side of the light guiding plate.

2. The backlight module as claimed in claim 1, wherein the first position limiting portions comprise a plurality of grooves.

3. The backlight module as claimed in claim 1, wherein the first position limiting portions comprise a plurality of position limiting planes, and the position limiting planes are oblique to a side surface of the light guiding plate.

4. The backlight module as claimed in claim 1, wherein the position limiting elements are symmetrically disposed around the back plate.

5. The backlight module as claimed in claim 4, wherein a shape of the back plate is substantially a rectangle, and the position limiting elements are respectively located at four corners of the back plate.

6. The backlight module as claimed in claim 1, further comprising:
at least one optical film, having a plurality of second position limiting portions, wherein the second position limiting portions respectively contact the position limiting elements to position the optical film on the light guiding plate;
a light reflecting layer, disposed between the back plate and the light guiding plate; and
a frame, assembled to the back plate for clamping the light guiding plate, the optical film, and the light reflecting layer between the frame and the back plate.

7. The backlight module as claimed in claim 6, further comprising:
a plurality of fastening members,
wherein each of the pillars has a fastening hole, the frame has a plurality of openings corresponding to the fastening holes, and the fastening members penetrate through the openings and are fastened in the fastening holes, so as to fasten the frame to the back plate.

8. The backlight module as claimed in claim 1, wherein the pillars comprise a plurality of columns or a plurality of polygon pillars.

9. The backlight module as claimed in claim 1, wherein a material of the cushion sheath comprises silicone, rubber or foam.

10. The backlight module as claimed in claim 1, wherein the light source comprises a cold cathode fluorescent lamp or a light emitting diode.
